(19) United States
(12) Patent Application Publication
(10) Pub. No.: US 2005/0221246 A1
(43) Pub. Date: Oct. 6, 2005

(54) Apparatus and method for liberating deleterious material from fine aggregate

(76) Inventors: Dan Drinkwater, Lakeview, OR (US); Stanley Novak JR., Phoenix, AZ (US); Duane Wetherbee, Tucson, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 10/976,738

(22) Filed: Oct. 29, 2004

Related U.S. Application Data
(60) Provisional application No. 60/516,261, filed on Oct. 31, 2003.

(51) Int. Cl. F27B 7/10

(52) U.S. Cl. 432/114

(57) ABSTRACT

A durability cell for liberating deleterious material from an aggregate material includes a body defining a chamber having a lower zone and an upper zone. An infeed opening is provided for the input of the aggregate material into the chamber lower zone. A discharge opening is provided for the exit of aggregate material from the chamber upper zone. A rotatable drive shaft is disposed within the chamber in a generally vertical orientation. At least one paddle is mounted to the drive shaft so as to lift aggregate material from the chamber lower zone toward the chamber upper zone when the drive shaft is rotated. The paddles can be adjustably mounted to the drive shaft so that the paddle angle with respect to vertical can be adjusted. An infeed chute is in communication with the chamber infeed opening. The chamber can include one or more baffles. The baffle can be removably mounted within the chamber. The removable baffle can be mounted within the chamber in either a first orientation wherein a first side of the baffle is subject to greater wear from aggregate material in the chamber when the drive shaft is rotating or a second orientation wherein a second side of the baffle is subject to greater wear from aggregate material in the chamber when the drive shaft is rotating.

### RELATED APPLICATIONS

This application claims the priority and benefit of U.S. Provisional Application No. 60/516,261, filed on Oct. 31, 2003, titled “Apparatus and Method for Liberating Deleterious Material from Fine Aggregate,” which is incorporated herein in its entirety by reference.

### BACKGROUND

This invention relates generally to the production of materials used in concrete and other cementious products. More particularly, it relates to an apparatus and method for liberating deleterious material from fine aggregate in order to improve the characteristics of the concrete or other products that are manufactured using the aggregate.

The characteristics relating to the ability of materials used in the construction of roadways, bridges, buildings, and the like, to resist deterioration from the environment or service in which they are placed is of great importance to many. For structures made using concrete, this ability to resist deterioration, or durability, is greatly affected by the ingredients used to produce the concrete. Concrete is made using a mixture of cement, water, and aggregate, with aggregate being the most significant ingredient by volume and by weight. Aggregates play an important role in determining the resistance of concrete to surface abrasion and wear. An aggregate that provides good concrete durability is hard, dense, and strong, and it is substantially free of soft, porous, or friable particles.

Test methods have been developed that predict the relative effectiveness of aggregates when used in concrete mixtures. The relative durability of aggregate materials is measured by several test methods, including the Los Angeles abrasion test and the California durability index, to name two. Both of these measures have been standardized by the American Society for Testing and Materials (ASTM) as relative indicators of the durability of an aggregate and, subsequently, of the durability of the concrete produced using the aggregate.

Another measure of the predicted effectiveness of an aggregate in contributing to a high durability concrete product is sand equivalency. Sand equivalency indicates the relative proportion of deleterious material such as clay or clay-like fines, organic material, and dust in fine aggregates or soil. As previously noted herein, the smaller the proportion of these deleterious materials that is present an aggregate used in a concrete mixture, the greater is the durability of the concrete product. A relative measure of sand equivalency is provided in a standard test method as outlined by the ASTM.

Aggregate producers, in an attempt to improve the quality of aggregate product, have used equipment and processes to increase the relative durability and sand equivalency of the aggregate they provide. Aside from seeking new mining claims which yield high quality sand or fine aggregate, aggregate producers have developed processes that improve the quality of the aggregate by removing clay, organic material, dust, and the like from the aggregate they mine. The processes that improve the quality of the aggregate product have become increasingly more significant in recent times as aggregate producers are forced to re-visit old mining claims since new mining claims are becoming increasingly more difficult to permit. These older claims have had the top cut, cleaner material mined, leaving a reserve containing more clay, organic material, and other deleterious material with lower than desired durability and sand equivalency characteristics.

A common technique in the art utilizes an apparatus to liberate deleterious material from the aggregate so that the deleterious material can be separated from the aggregate resulting in a product with higher durability and sand equivalency. These machines are referred to by many names including durability cells, attrition cells, attrition scrubbers and attrition mills, to name a few. As is commonly practiced in the art, aggregate enters the attrition cell from the top and flows downwardly to exit the machine near the bottom. These machines comprise one or more chambers and utilize impellers, paddles, or similar means well known in the art to liberate contaminants from the aggregate by the hitting or abrading of aggregate particles one against the other and against the impellers of the machine. The impellers or other scrubbing means commonly move rotationally, but any of a variety of other motions is used to agitate and abrade the aggregate.

The process of attrition, or the scrubbing of like material against like material, has proved to be only a marginally effective means for increasing the quality of aggregate. Durability and sand equivalency measures have been somewhat improved, but producers continue to strive for better results, particularly for material mined from secondary cut operations.

In many production environments, however, the state of the art does not provide for sufficient processing time, i.e.—the retention time within the attrition cell, to adequately abrade the material and sufficiently improve durability and sand equivalency. In order to control retention time in the machine of prior art, the chamber must be substantially full. If the chamber is only 50% full, retention time is 50% or less when compared to the retention time for a full chamber. Similarly, if the chamber is only 10% full, material can actually pass through the chamber without ever being abraded by the impellers or paddles. Because the flow rate of material through other processes in a typical aggregate processing plant is inconsistent, it is very difficult to maintain the chamber substantially full. Therefore, predicting the retention time for the product within the attrition cell chamber and thereby providing for a consistent quality level of the product is virtually impossible.

In view of the above discussion, there exists a need for an apparatus and method that provide for liberating deleterious material from fine aggregate. Accordingly, it is an object of the present invention to provide such an apparatus and method.

Another object of the invention is to provide such an apparatus and method that effectively abrades materials processed by the apparatus.

Yet another object of the invention is to provide such an apparatus and method that yields substantial material retention time.

Still another object of the invention is to provide such an apparatus and method that result in excellent control of material retention time.

Another object of the invention is to provide such an apparatus and method that result in high durability and sand equivalency of processed material.

Additional objects and advantages of the invention will be set forth in the description that follows, and in part will be apparent from the description, or may be learned by practice of the invention. The objects and advantages of the invention may be realized and obtained by the instrumentalities and combinations pointed out herein.

### SUMMARY

In accordance with the invention, there is provided a durability cell for liberating deleterious material from an aggregate material. The durability cell includes a body defining a chamber having a lower zone and an upper zone. An infeed opening is provided for the input of the aggregate material into the chamber lower zone. A discharge opening is provided for the exit of aggregate material from the chamber upper zone. A rotatable drive shaft is disposed within the chamber in a generally vertical orientation. At least one paddle is mounted to the drive shaft so as to lift aggregate material from the chamber lower zone toward the chamber upper zone when the drive shaft is rotated. The one or more paddles can be adjustably mounted to the drive shaft so that the paddle angle with respect to vertical can be adjusted. An infeed chute is in communication with the chamber infeed opening.

The chamber can include one or more baffles, whichs can be removably mounted within the chamber. The removable baffle can be mounted within the chamber in either a first orientation wherein a first side of the baffle is subject to greater wear from aggregate material in the chamber when the drive shaft is rotating or a second orientation wherein a second side of the baffle is subject to greater wear from aggregate material in the chamber when the drive shaft is rotating.

The drive can comprise a gear motor including an electric motor coupled to a set of gears coupled to the drive shaft. The rotational speed of the electric motor is variable and is controlled by an adjustable speed drive control which is in a closed loop relationship with the electric motor so that the current draw on the motor can be controlled to optimize the rotational speed of the drive shaft liberation of deleterious material from the feed material and to optimize retention time of aggregate material within the durability cell.

A method for liberating deleterious material from an aggregate material according to the invention includes the steps of: providing a chamber having a lower zone and an upper zone; feeding aggregate material into an infeed opening in the chamber lower zone; rotating a drive shaft disposed within the chamber in a generally vertical orientation wherein at least one paddle is mounted to the drive shaft so as to lift aggregate material from the chamber lower zone toward the chamber upper zone when the drive shaft is rotated; and discharging aggregate material from the chamber upper zone through a discharge opening.

### BRIEF DESCRIPTION OF THE DRAWINGS

The accompanying drawings, which are incorporated in and constitute a part of the specification, illustrate the presently preferred embodiments and methods of the invention and, together with the general description given above and the detailed description of the preferred methods and embodiments given below, serve to explain the principles of the invention.

FIG. 1 is a partially broken perspective view of an attrition cell according to the present invention.

FIG. 2 is a sectional elevation view of the attrition cell of FIG. 1, showing the motor, transmission and agitator of the cell.

FIG. 3 is a top plan view of the attrition cell of FIG. 1 showing the interior of the cell.

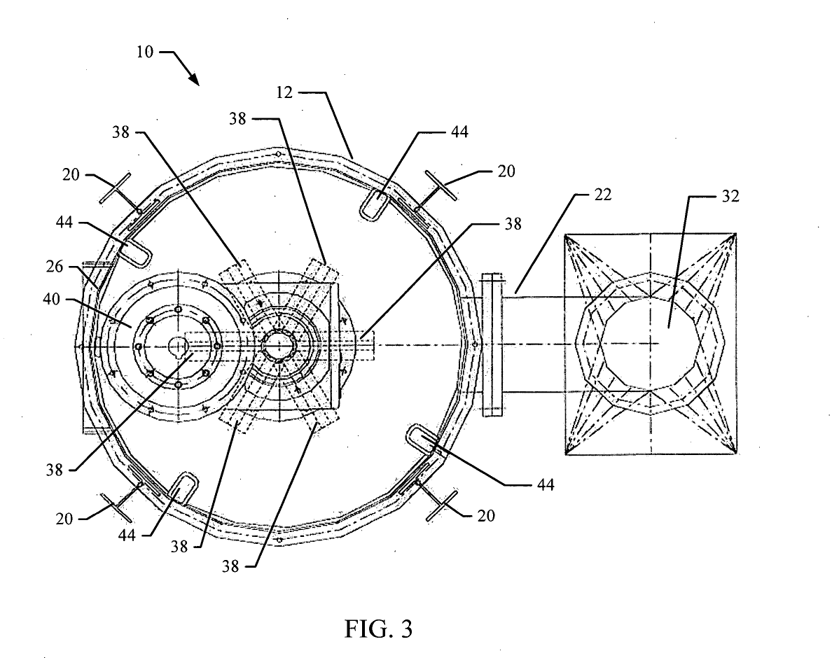

### DESCRIPTION

Reference will now be made in more detail to the presently preferred embodiments and methods of the present invention as illustrated in the accompanying drawings, in which like numerals refer to like parts throughout the several views.

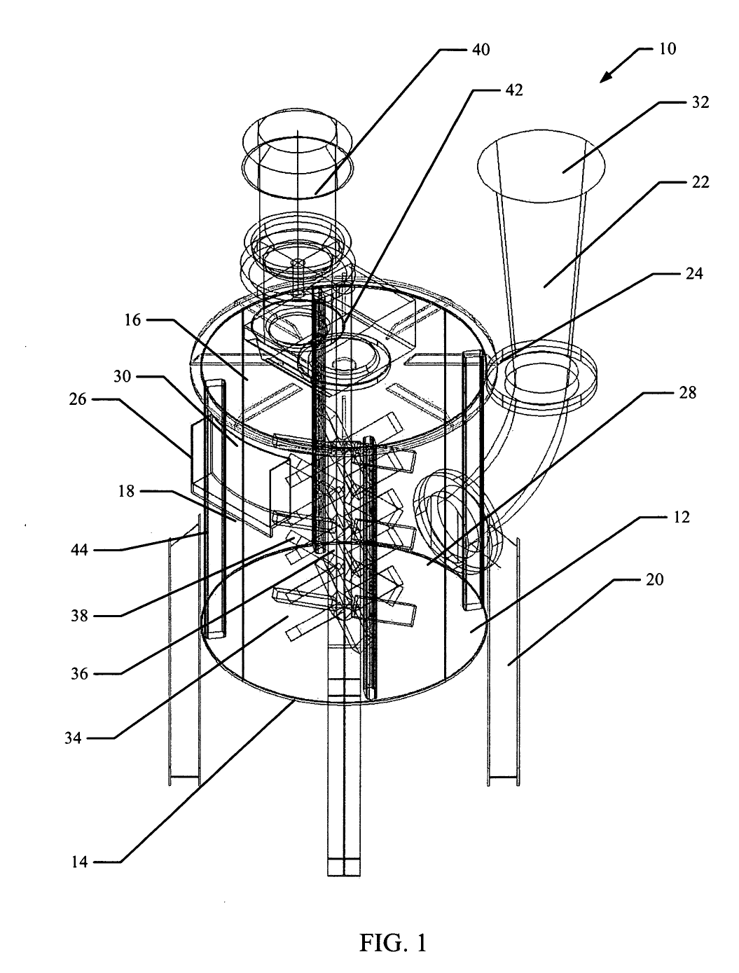

FIG. 1 illustrates an attrition cell 10 in accordance with the presently preferred embodiment of the invention. An outer shell 12, a bottom 14, and a lid 16 combine to form a tank or chamber 18. The outer shell 12 is generally cylindrical with open ends. The bottom 14 is rigidly attached to one end of the outer shell 12 and the lid 16 is removably attached to the opposite end of the outer shell 12, forming the chamber 18. A plurality of legs 20 depend downwardly when the outer shell 12 is oriented with the bottom 14 below the lid 16 and the longitudinal axis of the generally cylindrically shaped outer shell 12 is substantially vertical. The legs 20 support the outer shell 12 and stabilize the generally vertical orientation of the outer shell 12 when the attrition cell 10 is placed on a factory floor or the ground. The lid 16 is configured to cover the chamber 18. In the presently preferred embodiment of the invention, the outer shell 12, the bottom 14, the lid 16, and the legs 20 are formed from steel. In a presently preferred embodiment, the bottom 14 and the legs 20 are welded to the outer shell 12 and the lid 16 is clamped to the outer shell 12. As will be obvious to one of ordinary skill in the art, a variety of materials and construction techniques may alternatively be used. By way of example, the outer shell 12, the legs, 20, the bottom 14, and the lid 16 may be joined with screws, bolts, or other fasteners or may be brazed or alternately joined.

An infeed chute 22 has a mouth 32 at an upper end. The infeed chute 22 is rigidly secured to the outer shell 12 and penetrates the outer shell 12 near the bottom 14. The infeed chute 22 is configured to provide an input route from outside the attrition cell 10 to a lower zone 28 of the chamber 18. A bracket 24 is disposed intermediate and rigidly attached to the outer shell 12 and the infeed chute 22. The bracket 24 is configured to further secure and support the infeed chute 22. A discharge chute 26 penetrates the outer shell 12 and is proximate the lid 16. The discharge chute 26 is configured to provide an exit route from an upper zone 30 of chamber 18. In a presently preferred embodiment of the invention, the infeed chute 22 and the discharge chute 26 are formed using sheet metal and are welded to the outer shell as is commonly practiced in the art. Also in a presently preferred embodiment, the bracket 24 is made of steel and is welded to the outer shell 18 and the infeed chute 22. However, any of a variety of suitable materials well known in the art such as aluminum, for example, may be used to form the infeed chute 22, the bracket 26, and the discharge chute 26. Additionally, any of a wide variety of techniques such as the use of screws, bolts, and other fasteners may be used for securing the bracket 24, the infeed chute 22, and the discharge chute 26. In a presently preferred embodiment of the invention, the mouth 32 is higher than the discharge chute 26.

An agitator 34 comprises a shaft 36 and paddles 38. The shaft 36 is generally aligned with the vertical axis of outer shell 12 and is rotatably attached to the lid 16. The shaft 36 protrudes through the lid 16 such that a portion of the shaft 36 extends above the lid 16. The portion of the shaft 36 extending above the lid 16 is dynamically coupled to a motor 40 by way of a transmission 42. The motor 40 and the transmission 42 are configured to rotate the shaft 36 about the longitudinal axis of the shaft 36. Paddles 38 are attached to the shaft 36. The paddles 38 are oriented generally perpendicular to the shaft 36 and extend generally radially from the shaft 36. In a presently preferred embodiment, the shaft 36 and paddles 38 are manufactured from steel and the paddles 38 are bolted to the shaft 36. One of ordinary skill in the art will envision of variety of materials from which the shaft 36 and paddles 38 may be formed. Some examples of such materials include Ni-Hard, Wearalloy®, or Mangalloy® materials. Additionally, a variety of techniques, such as welding for example, may be used to attach the paddles 38 to the shaft 36. In one advantageous embodiment of the attrition cell 10, the paddles 38 are removably attached to the shaft 36, which facilitates changing paddles 38 for maintenance purposes or fitting the attrition cell 10 with an alternate paddle configuration. In a presently preferred embodiment of the invention, the motor 40 is an electric motor and is mounted to the transmission 42. The transmission 42 is a gear drive and is mounted to the lid 16. Shaft 36 extends through the transmission 42, and is keyed and coupled to the transmission 42 hollow output shaft. The gear motor is electrically coupled to an adjustable speed drive in a closed loop relationship with the electric motor on the gear motor so that the electrical current draw on the motor is maximized to optimize liberation of deleterious material from the feed material and to optimize retention time of the feed material within the durability cell.

Alternate motor and transmission types may be used such as, for example, a gasoline-powered engine and a belt and pulley drive configuration. Additionally, the motor 40 and transmission may be mounted in a variety of manners and in a variety of locations. For example, the motor 40 and transmission 42 may be mounted to a surface or structure that is separate from the attrition cell 10 of the present invention, or bearings could be used to mount shaft 36 to the lid 16 and bottom 14.

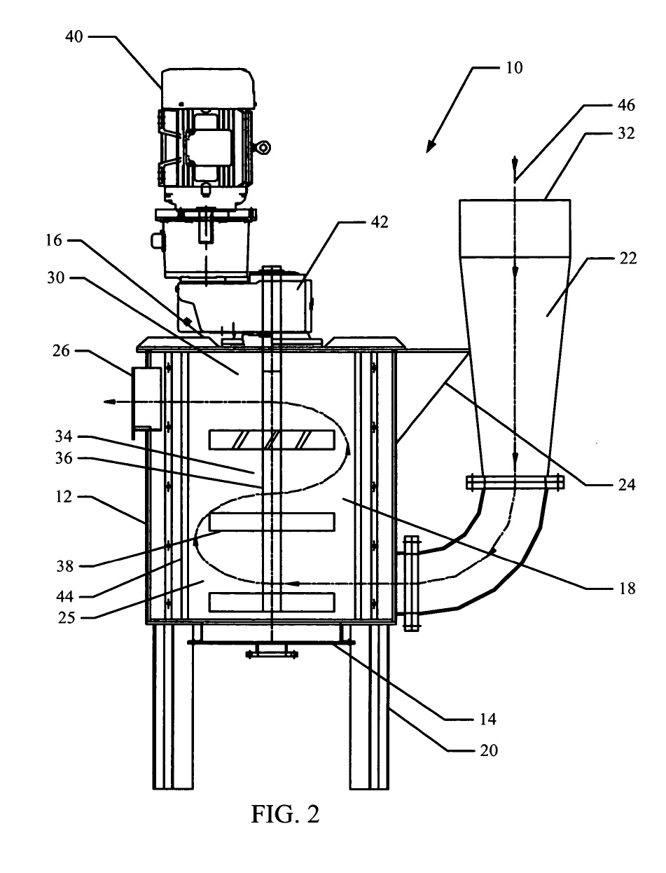

FIG. 2 shows the motor 40, the transmission 42, and the agitator 34 of a presently preferred embodiment of the invention. Three sets of paddles 38 are attached to the shaft 36. One set of paddles 38 is disposed proximate the bottom of the shaft 36, a second set of paddles 38 is disposed proximate the midpoint of the shaft 36, and a third set of paddles 38 is disposed proximate the top end of the shaft 36. Each set of paddles comprises four paddles 38. The paddles are configured to impart a lifting force upon material within the chamber 18. The paddles 38 are configured such that the surfaces of the paddles are at an angle with respect to horizontal, and, as the shaft 36 moves the paddles 38 within the chamber 18, the leading edge of each paddle 38 is lower than the trailing edge of the paddle 38. An angle of approximately 45 degrees has been shown to yield a good combination of lifting and abrading of the aggregate. The paddle orientation results in a generally upwardly circulating material flow 46. It should be noted that a multitude of paddle arrangements may be envisioned by one of skill in the art depending on a variety of factors including the material to be processed in the attrition cell 10 and the desired retention time within the chamber 18, to name two. A more vertical paddle results in more abrading and less lifting. A paddle that is too vertical will result in sand settling out of the slurry. Additionally, other embodiments of the agitator 34 may be implemented such as, for example, a screw-like agitator design. In one preferred embodiment, the infeed chute 22 is generally oriented at an angle of about 45 degrees with respect to the shaft 36. The angled infeed chute 22 is oriented in relation to the rotational direction of the shaft 36 such that the rotation of the shaft 36 will tend to pull aggregate material into the chamber 18 from the infeed chute 22.

In one advantageous embodiment of the invention, a plurality of baffles 44 is rigidly mounted to the interior of the outer shell 12 such that the baffles 44 protrude into the chamber 18. The baffles 44 may be made of any suitable material and may be mounted in any suitable manner. In a presently preferred embodiment, the baffles are made of steel and are welded or bolted to the outer shell 12. The envelope of the baffles 44 may be of a variety of shapes including, for example, rectangular and triangular prisms with the baffles 44 being configured to provide for an increase in surface area of the interior of the chamber 18. If the baffles 44 are removably mounted, such as by bolting, they can be easily replaced when worn. In one advantageous embodiment, removable baffles 44 can be removed, flipped over and remounted to the outer shell 12 to wear both sides of the baffles 44.

The attrition cell 10 in accordance with the present invention liberates deleterious material from sand or fine aggregate. The motor 40 is activated to rotate the agitator 34 within the chamber 18. The chamber 18 is charged with sand or fine aggregate material by way of the infeed chute 22. It should be noted that the sand or fine aggregate material may be dry or wetted with water or any other reagent that may aid in the liberation of deleterious material from the sand or fine aggregate. The agitator 34, by way of the paddles 38, mixes, lifts, and abrades the aggregate present the chamber 18 such that the aggregate migrates generally from the lower zone 28 to the upper zone 30 and is discharged from the chamber 18 by way of the discharge chute 26. The material flow from the infeed chute 22 to the discharge chute 26 is facilitated by the lifting imparted it by the paddles 38 in combination with volumetric flow.

The chamber 18 is substantially filled with material when material exits the chamber 18 by way of the discharge chute 26, providing for a longer duration of material processing retention time and considerably more control over the retention time than is realized in the prior art. The realized material retention time of the presently preferred embodiment of the invention is determined by a number of factors including the chamber volume, the material feed rate, the quantity of paddles 38 present the agitator 34, the surface area and angle of the paddles 38, the rotational velocity of the agitator 34, and the quantity and shape of the baffles 44. A baffle of rectangular shape, with the long axis of the rectangle extending radially inward from the outer shell 12, has been found to maximize the liberation of deleterious material from the aggregate. A triangular shaped baffle is less effective at liberating deleterious material, but reduces the wear rate.

The attrition characteristics of the present invention are improved over those of prior art due to the improved control of the process as described above. Additionally, the rotational and lifting features of the agitator 34 provide for improved abrading of the material particles, one against another and against the paddles 38. Due to the abrasive nature of the process, the parts of the attrition cell 10 within the chamber 18 are subject to abrasive wear during use. In an alternate embodiment of the invention, the interior of the outer shell 12, the shaft 36, the paddles 38, and the baffles 44 can be coated with a non-abrasive material to reduce wear and extend service life such as, for example, latex or polyurethane.

From the foregoing, it can be seen that the embodiments of the apparatus and method for liberating deleterious material from fine aggregate of the present invention offer a number of advantages. The invention provides an apparatus and method that results in effective abrading of materials processed by the apparatus and that yields substantial material retention time. Additionally, the apparatus and method of the present invention provide excellent control of material retention time. Use of the apparatus and method of the invention produces aggregate or fine sand with high durability and sand equivalency measures.

While certain preferred embodiments and methods of the invention have been described, these have been presented by way of example only, and are not intended to limit the scope of the present invention. Additional advantages and modifications may readily occur to those skilled in the art. Therefore, the invention in its broader aspects is not limited to the specific embodiments, methods and conditions described herein, which are not meant to and should not be construed to limit the scope of the invention. Accordingly, departures may be made from such embodiments and methods, variations may be made from such conditions, and deviations may be made from the details described herein without departing from the spirit or scope of the general inventive concept as defined by the appended claims and their equivalents.

1. A durability cell for liberating deleterious material from an aggregate material, the durability cell comprising:
a body defining a chamber having a lower zone and an upper zone;
an infeed opening to allow for the input of aggregate material into the chamber lower zone;
a discharge opening to allow for the exit of aggregate material from the chamber upper zone;
a rotatable drive shaft disposed within the chamber in a generally vertical orientation;
at least one paddle mounted to the drive shaft and adapted to lift aggregate material in the chamber lower zone toward the chamber upper zone when the drive shaft is rotated.

2. The durability cell of claim 1 wherein the chamber includes one or more baffles.

3. The durability cell of claim 1 wherein the paddle is adjustably mounted to the drive shaft so that the paddle can be oriented at different angles with respect to vertical.

4. The durability cell of claim 1 further comprising an infeed chute in communication with the chamber infeed opening.

5. The durability cell of claim 4 wherein the infeed chute is generally oriented at an angle with respect to the drive shaft.

6. The durability cell of claim 5 wherein the infeed chute angle with respect to the drive shaft is about 45 degrees.

7. The durability cell of claim 5 wherein the infeed chute is oriented in relation to the rotational direction of the drive shaft so that rotation of the drive shaft will tend to pull aggregate material disposed within the infeed chute into the chamber.

8. The durability cell of claim 2 wherein one or more of the baffles is removably mounted within the chamber.

9. The durability cell of claim 8 wherein the one or removably mounted baffles can be mounted within the chamber in either a first orientation wherein a first side of the baffle is subject to greater wear from aggregate material in the chamber when the drive shaft is rotating or a second orientation wherein a second side of the baffle is subject to greater wear from aggregate material in the chamber when the drive shaft is rotating.

10. The durability cell of claim 1 wherein the drive comprises:
an electric motor that can be operated at a variable rotational speed; and
a sensor for sensing the rotational speed of the motor and coupled to the electric motor in a closed loop relationship;
whereby the electric motor can be operated at a set rotational speed for optimizing retention time of the aggregate material within the durability cell.

11. A method for liberating deleterious material from an aggregate material, the method comprising:
providing a chamber having a lower zone, an upper zone and a drive shaft disposed within the chamber in a generally vertical orientation, the drive shaft having at least one paddle is configured so as to lift aggregate material from the chamber lower zone toward the chamber upper zone when the drive shaft is rotated;
feeding aggregate material into the chamber lower zone;
rotating the drive shaft to lift the aggregate material from the chamber lower zone to the chamber upper zone; and
discharging aggregate material from the chamber upper zone.

12. The method of claim 11 wherein the chamber includes one or more baffles.

13. The method of claim 11 wherein the paddle is adjustably mounted to the drive shaft so that the paddle can be oriented at different angles with respect to vertical.

14. The method of claim 11 wherein feeding aggregate material into the chamber comprises feeding aggregate material through an infeed chute in communication with the chamber lower zone.

15. The method of claim 14 wherein the infeed chute is generally oriented at an angle with respect to the drive shaft.

16. The method of claim 15 wherein the infeed chute angle with respect to the drive shaft is about 45 degrees.

17. The method of claim 14 wherein the infeed chute is oriented in relation to the rotational direction of the drive shaft so that rotation of the drive shaft will tend to pull aggregate material disposed within the infeed chute into the chamber.

18. The method of claim 12 wherein the baffles are removably mounted within the chamber.

19. A durability cell for liberating deleterious material from an aggregate material, the durability cell comprising:
a body defining a chamber having a lower zone and an upper zone;
feeding means for feeding aggregate material into the chamber lower zone;
agitator means for lifting aggregate material in the chamber lower zone toward the chamber upper zone while mixing and abrading the aggregate material; and
discharge means for allowing the aggregate material to exit the chamber from the chamber upper zone.

20. The durability cell of claim 19 further comprising drive means for driving the agitator means.

21. The durability cell of claim 19 wherein the feeding means comprises an infeed chute in communication with an infeed opening into the chamber lower zone.

22. The durability cell of claim 19 wherein the agitator means comprises a rotatable drive shaft disposed within the chamber in a generally vertical orientation.

23. The durability cell of claim 22 wherein the agitator further comprises one or more paddles mounted to the drive shaft.

24. The durability cell of claim 23 wherein one or more of the paddles mounted to the drive shaft is removably mounted to the drive shaft.

25. The durability cell of claim 20 wherein the drive means includes a motor that is coupled to a transmission and wherein the transmission is coupled to the drive shaft.

26. The durability cell of claim 25 wherein the motor can be controllably operated at a variable rotational speed.

27. The durability cell of claim 26 wherein:
the drive means further comprises a sensor for sensing the rotational speed of the motor, the sensor being coupled in a closed loop relationship to a speed control for controlling the rotational speed of the motor;
whereby the motor can be operated at a set rotational speed for optimizing retention time of the aggregate material within the durability cell.

28. The durability cell of claim 25 wherein the motor is an electric motor and

29. The durability cell of claim 19 further comprising one or more baffles mounted within the chamber.

30. The durability cell of claim 19 wherein the chamber has an interior coated, at least in part, with a non-abrasive material.

31. The durability cell of claim 22 wherein drive shaft is coated, at least in part, with a non-abrasive material.

32. The durability cell of claim 23 wherein one or more of the paddles is coated, at least in part, with a non-abrasive material.
